(19) United States
(12) Patent Application Publication
(10) Pub. No.: US 2026/0192480 A1
(43) Pub. Date: Jul. 9, 2026

(54) CHAIN OF CHAIN SAW

(71) Applicants: Sang-eun CHUNG, Suwon-si (KR); Who-sun PARK, Suwon-si (KR)

(72) Inventors: Sang-eun CHUNG, Suwon-si (KR); Who-sun PARK, Suwon-si (KR)

(21) Appl. No.: 19/555,880

(22) Filed: Mar. 3, 2026

Related U.S. Application Data
(63) Continuation-in-part of application No. 18/357,960, filed on Jul. 24, 2023.

(30) Foreign Application Priority Data
Aug. 2, 2022 (KR) 10-2022-0095876
Jun. 5, 2023 (KR) 10-2023-0072019

(51) Int. Cl. B27B 33/14; B28D 1/12

(52) U.S. Cl. CPC B27B 33/142; B28D 1/124

(57) ABSTRACT

Provided is a chain of a chain saw. The chain includes: a chain link segment in which a drive link formed with mounting holes on both sides thereof and a pair of side links each formed with pin holes on both sides thereof are coupled by a connection pin to form a track. An outer bushing having an outer diameter to be force-fitted into the mounting hole of the drive link as a circular hole is coupled to the mounting hole, and an inner bushing having an outer diameter to be inserted into a circular inner diameter of the outer bushing is coupled.

### BACKGROUND

### 1. Technical Field

Various embodiments generally relate to a chain saw, and more particularly, to a chain of a chain saw, in which cutting force is actively provided by stably mounting an abrasive on a drive link, double bushings with a good fixing force are used, friction between a link and a connection pin is induced into friction between links, and neighboring drive links operate in an interlocked manner by being meshed with each other upon actuation to improve drive transmission power.

### 2. Related Art

In general, a chain saw is configured such that a cutting chain mounted with an abrasive material including diamond powder or the like rotates in an infinite trajectory by a power source, and is used when cutting or trimming steel, concrete or the like. Depending on the type of power source, there are a gasoline chain saw which uses fuel, an electric chain saw which uses an electric motor, and a hydraulic chain saw which uses hydraulic pressure.

For example, as illustrated in FIG. 1, a chain saw includes a body 10 in which a power source is disposed, a guide plate 11 which is fixed to the body 10 and protrudes outward, and a chain 12 which is installed to rotate in an infinite trajectory along the edge of the guide plate 11. The chain 12 may include a plurality of drive links which are mounted to transmit power of a power source, side links which are mounted to connect the drive links, and abrasives which are mounted to cut an object to be cut by generating friction with the object to be cut.

An example of a mounting structure among such drive links, side links and abrasives is disclosed in U.S. Pat. No. 8,651,005, and will be described below with reference to FIGS. 2 and 3. First, as illustrated in FIG. 3, side links 21 are disposed to connect neighboring drive links 20, and the drive links 20 and the side links 21 may be coupled to each other by connection pins 22 which pass through the drive links 20 and the side links 21 overlapping with each other. Cutting links 23 are disposed to connect neighboring drive links 20, and the drive links 20 and the cutting links 23 may be coupled to each other by connection pins 22 which pass through the drive links 20 and the cutting links 23 overlapping with each other. Abrasives 24 for cutting an object to be cut by generating friction directly with the object to be cut may be provided by being fused or electro-deposited on portions of the cutting links 23.

In this way, as the coupling of the drive link 20 and the side link 21 and the coupling of the drive link 20 and the cutting link 23 are alternately disposed as illustrated in FIG. 3, the chain 12 (see FIG. 1) of a chain saw may be configured.

However, since the chain is configured such that power of a power source is transmitted from the drive link 20 to the cutting link 23 and the cutting link 23, that is, the abrasive 24, cuts the object to be cut, loss of power of the power source may be caused and thus cutting force may be weak compared to power of the power source.

Also, since distribution and balance of force between the cutting link 23 which transmits, to the drive link 20, force of various magnitudes and directions generated due to friction with the object to be cut and the drive link 20 which transmits power of the power source to the cutting link 23 repeatedly conflict with each other, a problem may arise in that wear increases by a structure in which a coupling portion where the connection pin 22 is installed receives a large amount of force.

In addition, due to conflict of force between the cutting link 23 and the drive link 20, wear of the connection pin 22 intensifies, and eventually, coupling between the cutting link 23 and the drive link 20 becomes loose. Therefore, noise may be generated in the cutting link 23 and the drive link 20 during work, and if this situation is left unattended, the total length of the chain 12 eventually increases, making it inconvenient to use the chain 12 due to frequent chain length correction and shortening the service life of the chain 12.

Further, coupling between the drive link 20, the side link 21 and the cutting link 23 is made by the connecting pins 22, and frictional force with the drive link 20, the side link 21 or the cutting link 23, provided to the connection pin 22, is concentrated in a curved section of the infinite trajectory. Therefore, as the wear of the connection pin 22 intensifies, coupling portions between the drive link 20, the side link 21 and the cutting link 23 become loose or loosen, and as the gap between the cutting link 23 and the drive link 20 widens, installation tension of the chain 12 decreases to increase the length of the chain 12, causing a problem in that the risk of breakage of the connection pin 22 is high.

The reason to this resides in that the connection pin 22 is a rivet which is coupled through riveting. The rivet has a structure in which both ends of the connection pin 22 are fixed by being deformed by pressure in order to quickly and smoothly connect and couple links in a chain structure.

Therefore, the connection pin 22 cannot help but have physical properties from which rigidity cannot be expected.

Thus, in a work of cutting a relatively rigid material such as metal or concrete with a diamond abrasive, there is a problem in that a chain easily loosens due to large wear.

For the above reasons, a user of a chain saw has inconvenience of having to frequently decrease the length of the chain that loosens due to an increasing gap between connection links constituting the chain, rather than inconvenience and economic loss due to wear of an abrasive according to the main functional purpose of the chain saw.

Moreover, in a severe case, there may arise a problem in that even though the service life of the abrasive remains, the chain cannot be used due to loosening and cutting breakage of links.

### PRIOR ART DOCUMENT

### Patent Document

(Patent Document 1) U.S. Pat. No. 8,651,005 B2 (registered on Feb. 18, 2014)
(Patent Document 2) U.S. Pat. No. 10,343,302 B2 (registered on Jul. 9, 2019)
(Patent Document 3) Korean Patent No. 10-1568102 (published on Nov. 12, 2015)
(Patent Document 4) Korean Utility Model Application Publication No. 20-2012-0000783 (published on Feb. 2, 2012)
(Patent Document 5) Korean Utility Model Application Publication No. 20-2012-0000779 (published on Feb. 2, 2012)

### SUMMARY

An object of the present disclosure made to solve the above problems is to provide a chain of a chain saw, in which an abrasive is stably mounted on a drive link and drive links are connected by side links, so that driving force of a power source may be directly transmitted as cutting force for cutting an object to be cut.

An object of a preferred example of the present disclosure is to minimize elongation of a chain by minimizing frictional force on a relatively soft connection pin by inducing friction between bearings by double bearing coupling of an outer bushing mounted in a mounting hole of a drive link and an inner bushing rotationally limited by a connection link.

An object of another preferred example of the present disclosure is to provide a chain of a chain saw, in which a rib of a side link is fitted and coupled into a mounting hole of a drive link, so that friction between a connection pin and links in a curved section during driving of the chain is replaced by friction between the side link and the drive link, thereby significantly reduce occurrence of a gap caused by frictional wear due to direct friction with the connection pin.

Another object of the present disclosure is to provide a teeth meshing interlocking structure between adjacent drive links to stably and uniformly improve driving transmission force of a drive link, eventually increasing driving transmission force of a chain.

Still another object of the present disclosure is to place a bumper protrusion for preventing an obstacle on a central upper portion of a side link, thereby preventing an obstacle such as a steel reinforcing bar or a concrete fragment from being introduced and lost during work.

Yet still another object of the present disclosure is to provide a kit which is good to perform a work for reducing elongation of a chain or replacing any one single drive link unit.

In order to achieve the above objects, in accordance with an embodiment of the present disclosure, in a chain of a chain saw which cuts an object to be cut while being rotated in an infinite trajectory, the chain includes a drive link in which an abrasive is mounted on an upper portion of a plate shape and which is formed with mounting holes on both sides thereof, a pair of side links each of which is formed with pin holes on both sides thereof connecting neighboring drive links, and a connection pin which pivotally couples overlapping portions of the drive link and the side links.

In order to achieve the above objects, in accordance with an embodiment of the present disclosure, a chain of a chain saw includes a chain link segment in which a drive link formed with mounting holes on both sides thereof and a pair of side links each formed with pin holes on both sides thereof are coupled by a connection pin to form a track, wherein concave and convex portions which are engaged with adjacent drive links are formed on both sides of the drive link.

For example, an upper portion of the drive link is flat or has a gently convex arc, and by forming an abrasive coupling groove on the upper portion of the drive link, engagement projections are formed at left and right ends of the groove.

The abrasive is seated in the flat groove on the upper portion of the drive link, and is attached and fixed as a sintering tip which is fixed as left and right end surfaces of the abrasive are engaged with the engagement projections on the upper portion of the drive link.

For another example, the groove of the drive link has a gently convex arc so that engagement projections are formed at left and right ends of the groove.

The groove may include at least one coupling protrusion.

A fusion tip fixed to the groove is formed by attaching diamond powder or the like to an upper surface of a drive link cap which has a channel-shaped cross-section covering a bottom of the gently convex arc-shaped groove of the drive link and front and rear wall surfaces of the drive link, and left and right end surfaces of the drive link cap are engaged with the engagement projections on the upper portion of the drive link.

When forming a coupling protrusion on a bottom of the gently convex arc-shaped groove of the drive link, a coupling hole is formed at a corresponding position of the drive link cap.

Round type protruding pieces are provided on central front and rear portions of the drive link cap.

The drive link has a substantially pentagonal plate shape, and is configured to form a tooth groove between adjacent drive links, into which a sprocket of the chain saw is meshed.

The drive link has mounting holes on both sides of a front surface thereof, the side link has pin holes formed on both sides of a front surface thereof, O-ring grooves are formed around both the mounting holes on front and rear surfaces of the drive link, and O-rings 131 are coupled in the O-ring grooves between the pair of side links and the drive link.

As an example of a coupling portion of the connection pin, a rib which is axially coupled to an inner diameter surface of the mounting hole of the drive link is provided around the pin hole on one surface of the side link.

As another example of the coupling portion of the connection pin, the connection pin is pivotally coupled by using an outer bushing having an elliptical outer diameter and an inner bushing having an outer diameter to be inserted into a circular inner diameter of the outer bushing.

A protrusion is formed on one surface of the inner bushing, and a notch groove is formed in the side link at a corresponding position, so that pivot friction occurs only on the outer bushing and the inner bushing.

A bumper protrusion for preventing introduction of an obstacle may be configured to protrude from a central upper portion of the side link.

As an optional repair kit, a side link for repair in which a female screw portion is formed on an inner diameter surface of the pin hole of the side link and a bolt which is coupled to the female screw portion may be further included.

Since a tip installed by being attached to a drive link which receives power of a driving source directly cuts an object to be cut, the received power may be provided as cutting force as it is, thereby improving cutting efficiency.

In addition, pivot coupling of a connection pin has a configuration in which the connection pin is pivotally coupled to an outer bushing fixed by being fitted into an elliptical mounting hole of the drive link and having an outer diameter of an ellipse and an inner bushing including a protrusion fixed by being coupled into a notch groove of a side link. Therefore, a bearing effect between the bushings is provided, and the connection pin coupled to the inner bushing serves to fix and maintain a chain structure, that is, the drive link and the connection link.

Therefore, there is an effect of significantly reducing the wear rate of a plurality of pivot coupling parts for forming the channel structure while a chain is driven, thereby maintaining relatively stable chain tension while the chain is used.

As another embodiment, ribs of side links are inserted into a mounting hole of a drive link so that the side links and the drive links are primarily locked. Therefore, friction between a connection pin, a drive link and side links that occurs in the curved section of an infinite trajectory in the conventional art may be excluded and may be replaced with friction between the drive link and the side links. Due to this fact, there is an effect of minimizing a phenomenon in which a gap widens due to frictional wear between the connection pin and the links in the conventional art and of maintaining the tension of the chain relatively well.

As the side link performs only a simple function of secondarily locking neighboring drive links instead of abrasive attaching and cutting functions in the conventional art, the side link may be manufactured into a smaller and simpler shape than the side link according to the conventional art. Due to this fact, since the weight of a chain saw may be reduced, an effect of reducing the load of a chain saw engine and an effect of lowering the cost of the chain saw may be achieved.

Furthermore, as the drive link forms a tooth groove in link with an adjacent drive link and is interlocked with a driving sprocket in a meshed manner, irregular operating force with which each drive link tries to move independently on its own is limited, and thus, an effect of stabilizing the driving of the entire chain is achieved.

On the other hand, nevertheless, when the length of the chain increases as a pivot between the drive link and the side link becomes loose due to influence of the temperature of working environment or long-term use of the tip attributable to improvement in durability, the coupling of the pivot may be released to separate the links, and may be simply replaced with a repair kit of the present disclosure through removal and assembly, thereby increasing the service life of the chain.

### BRIEF DESCRIPTION OF THE DRAWINGS

The accompanying drawings illustrate preferred embodiments of the present disclosure and, together with the foregoing disclosure, serve to provide further understanding of the technical spirit of the present disclosure. However, the present disclosure is not to be construed as being limited to the drawings.

FIG. 1 is a perspective view schematically illustrating a conventional chain saw.

FIGS. 2 and 3 are front views illustrating a part of a chain of a conventional chain saw.

FIG. 4a is a front view illustrating a part of a chain which is assembled with a connection link having a bumper protrusion in a pivotally coupled state of inner and outer bushings in accordance with a first embodiment of the present disclosure.

FIG. 4b is a front view illustrating a part of a chain assembled in a pivotally coupled state between links in accordance with the first embodiment of the present disclosure.

FIG. 5a is a cross-sectional view of an axial coupling part of FIG. 4a.

FIG. 5b is a cross-sectional view of an axial coupling part of FIG. 4b.

FIG. 6a is a front view illustrating a part of a chain in a pivotally coupled state of inner and outer bushings in accordance with a second embodiment of the present disclosure.

FIG. 6b is a front view illustrating a part of a chain in a pivotally coupled state between links in accordance with the second embodiment of the present disclosure.

FIG. 7a is a cross-sectional view of an axial coupling part of FIG. 6a.

FIG. 7b is a cross-sectional view of an axial coupling part of FIG. 6b.

FIG. 8a is an enlarged cross-sectional view of a state in which an O-ring is added in the pivotally coupled state of the inner and outer bushings.

FIG. 8b is an enlarged cross-sectional view of a state in which an O-ring is added in the pivotally coupled state between the links.

FIG. 9a is an exploded perspective view of the chain in the pivotally coupled state of the inner and outer bushings in accordance with the first embodiment of the present disclosure, and FIG. 9b is an exploded perspective view of the chain in the pivotally coupled state between the links in accordance with the first embodiment of the present disclosure.

FIG. 10a is an exploded perspective view of the chain in the pivotally coupled state of the inner and outer bushings in accordance with the second embodiment of the present disclosure, and FIG. 10b is an exploded perspective view of the chain in the pivotally coupled state between the links in accordance with the second embodiment of the present disclosure.

FIG. 11a is a perspective view of a part of the chain in the pivotally coupled state of the inner and outer bushings in accordance with the first embodiment of the present disclosure, and FIG. 11b is a perspective view of a part of the chain in the pivotally coupled state between the links in accordance with the first embodiment of the present disclosure.

FIG. 12a is a perspective view of a part of the chain in the pivotally coupled state of the inner and outer bushings in accordance with the second embodiment of the present disclosure, and FIG. 12b is a perspective view of a part of the chain in the pivotally coupled state between the links in accordance with the second embodiment of the present disclosure.

FIG. 13 is a cross-sectional view of a pivotally coupled state between links which are coupled by a replacement kit in accordance with the present disclosure.

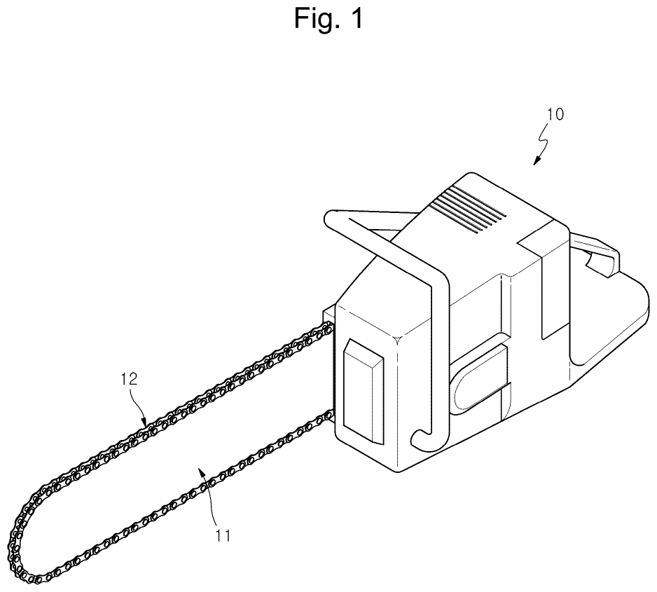

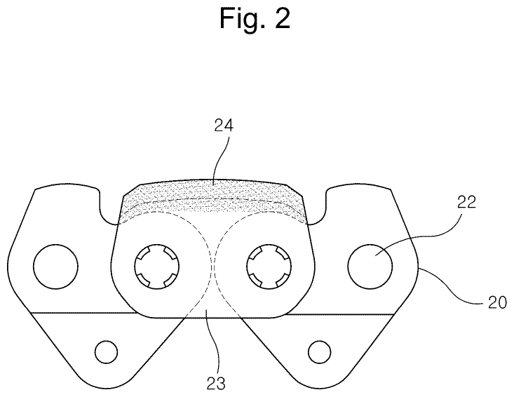

### DETAILED DESCRIPTION

Hereinafter, exemplary embodiments of the present disclosure are described in detail with reference to the accompanying drawings in order for those skilled in the art to be able to readily practice the present disclosure. In describing an operational principle relating to the embodiments of the present disclosure, however, when a detailed description of relevant functions or constructions is deemed to make the subject matter of the present disclosure unnecessarily obscure, the detailed description will be omitted.

In the present disclosure, concave and convex portions 140 to be meshed with adjacent drive links are formed on both sides of a drive link.

Double bushings are disposed in a mounting hole in which a drive link and a connection link are pivotally coupled, to perform the function of a friction bearing, so that wear friction between the pivotally coupled links according to driving of an entire chain is relatively stabilized.

In addition, main points of the present disclosure are to stably couple an abrasive to the drive link and to provide a repair kit for replacement.

### First Embodiment

A chain of a chain saw in accordance with a first preferred embodiment of the present disclosure is an example in which a sintering tip for handling a material such as concrete is installed by being attached to the top of a drive link.

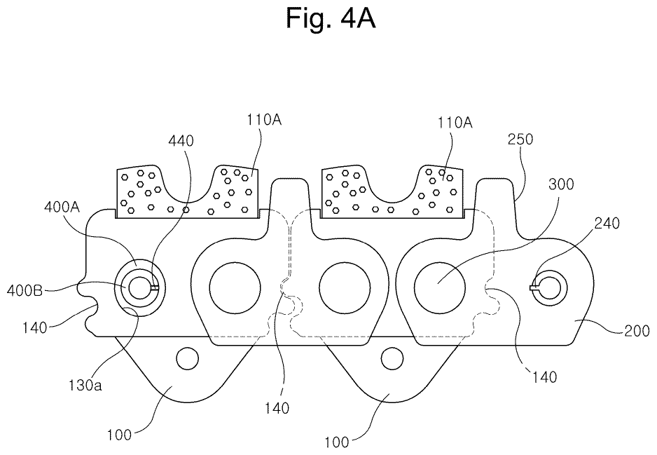

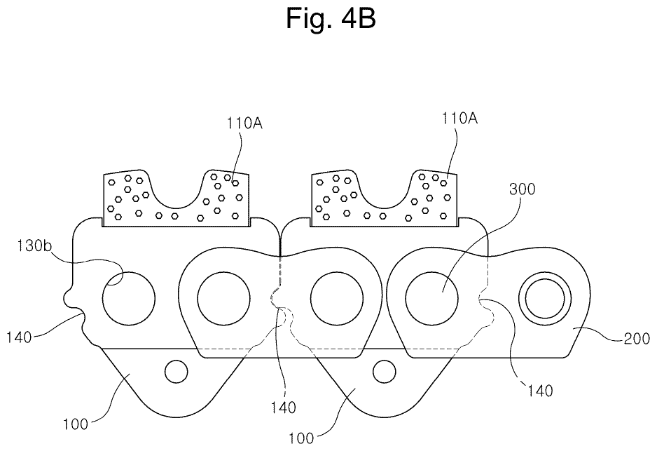

This will be described below with reference to FIGS. 4a, 4b, 5a, 5b, 9a and 9b.

The chain of a chain saw in accordance with the present disclosure is composed of a chain link segment (hereinafter referred to as a ‘chain’) in which a drive link 100 formed with mounting holes on both sides thereof and a pair of side links 200 each formed with pin holes 210 on both sides thereof are connected to each other by connection pins 300 to form a track.

Concave and convex portions 140 which are engaged with adjacent drive links 100 are formed on both sides of the drive link 100.

The drive link 100 is a link which directly receives power of a power source to cut an object to be cut. The drive link 100 has a configuration in which an abrasive is mounted on the top of the drive link 100 and two drive links 100 are pin-coupled at lower portions thereof by connection pins 300 with a pair of side links 200 disposed to overlap with the two drive links 100 at front and rear.

In general, the chain of a chain saw is configured to cut an object to be cut, while being rotated in an infinite trajectory by left and right sprockets.

A drive link of the chain is the drive link 100 on the top of which a sintering tip 110A is mounted.

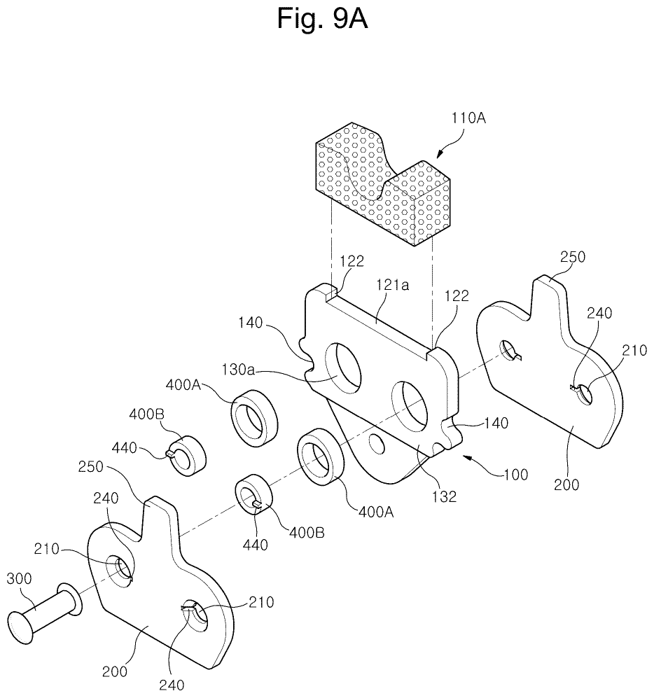

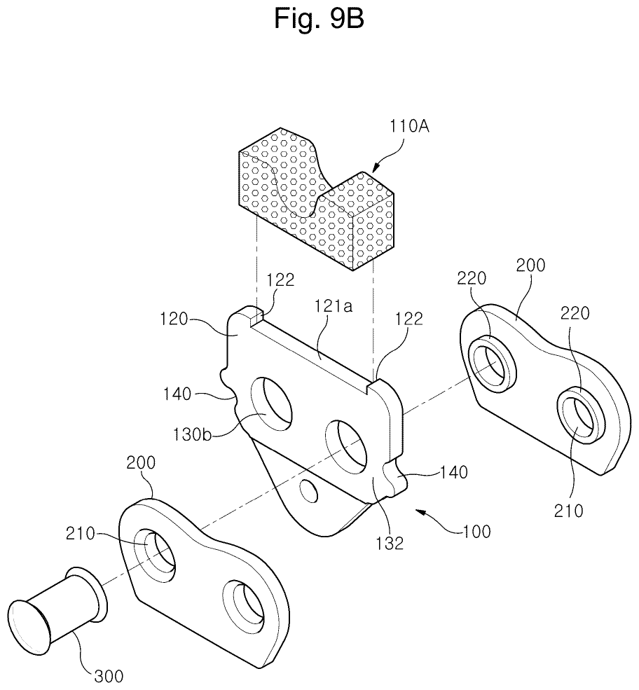

As a preferred example, as illustrated in FIG. 9a, a flat groove 121a is formed on an upper portion 120 of the drive link 100. Due to formation of the groove 121a, engagement projections 122 are formed at the left and right ends of the upper portion 120.

The sintering tip 110A has a structure in which the sintering tip 110A is appropriately restrained by the bottom surface of the groove 121a and the engagement projections 122 formed on the upper portion 120 of the drive link 100. Also, a protrusion 440 is formed one surface of the inner bushing 400B, and a notch groove 240 is formed in the pin hole of the side link at a corresponding position.

The sintering tip 110A is formed such that the left and right end surfaces of the sintering tip 110A are attached and fixed by being engaged with the engagement projections 122 of the groove 121a formed on the upper portion 120 of the drive link 100.

The chain for a chain saw, including the drive link 100 to which the sintering tip 110A is attached, is used to cut a block such as a wall and a pillar and a concrete structure.

### Second Embodiment

A chain of a chain saw in accordance with a second preferred embodiment of the present disclosure is an example in which a fusion tip for handling a material such as a steel reinforcing bar and a steel pipe is installed by being attached to the top of a drive link.

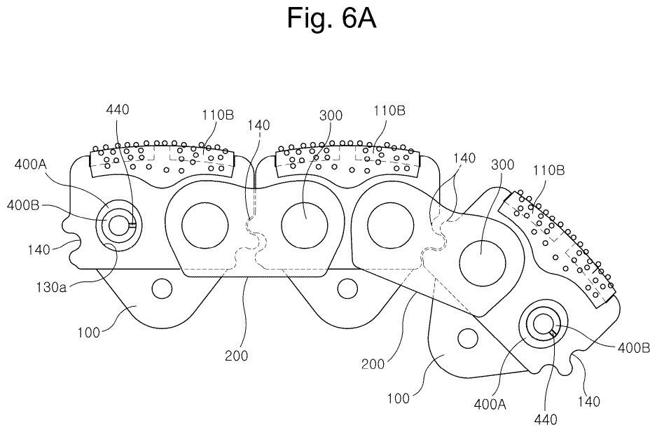

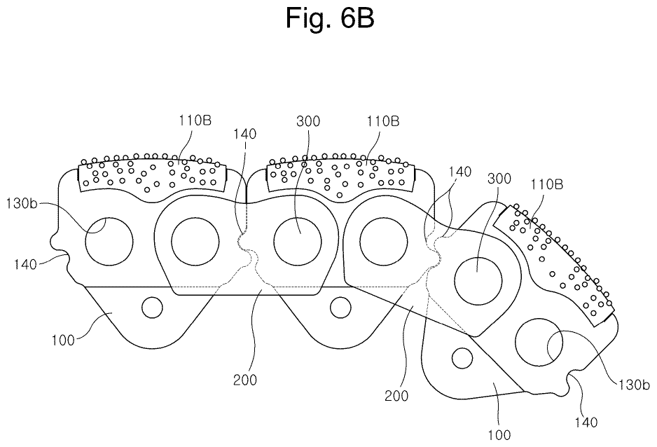

This will be described below with reference to FIGS. 6a, 6b, 7a, 7b, 10a and 10b.

Unlike the groove 121a for coupling the sintering tip 110A, a groove 121b which has a gently convex curvature as a whole is formed on an upper portion 120 of a drive link 100.

At least one coupling protrusion 123 may be formed in the groove 121b to which a fusion tip 110B of the drive link 100 is to be coupled.

An abrasive is a fusion tip in which diamond particles are fused to a segment base using a bond.

The segment base is formed as a drive link cap 114 having a channel-shaped cross-section including a groove 112 which covers the groove 121b on the upper portion 120 of the drive link 100 and a coupling hole 113 into which the coupling protrusion 123 on the upper portion 120 of the drive link 100 is inserted.

The fusion tip 110B in which diamond powder 115 is fused to the upper surface of the drive link cap 114 is disposed by fusion, electro-deposition or mixing of fusion and electro-deposition between the groove 121b of the drive link 100 and the groove 112 of the drive link cap 114 (hereinafter referred to as a ‘fusion tip’).

The left and right end surfaces of the drive link cap 114 of the fusion tip 110B are engaged by engagement projections 122 of the groove 121b formed on the upper portion 120 of the drive link 100, and the coupling hole 113 is stably coupled and attached to the coupling protrusion 123 of the upper portion 120 of the drive link 100. Thus, more stable coupling force between the drive link 100 and the fusion tip 110B is maintained, so that it is possible to perform good work when cutting a metal structure such as cast carbon steel.

The coupling hole 113 may be formed as a coupling groove.

Round type protruding pieces 116 may be provided on central front and rear portions of the drive link cap 114.

Therefore, by increasing an area where the central front and rear portions of the drive link cap 114 are coupled and fixed to the drive link 100, it is possible to increase fixing force and ensure stability against impact force upon work.

By using different materials for the drive link 100 and the drive link cap 114, it is efficient to induce appropriate wear of a material during a cutting work.

As a common structure of the first and second embodiments, concave and convex portions 140 which are meshed with edges of adjacent drive links 100 are formed on edges of both sides of the drive link 100.

Due to this fact, although the drive links 100 are restrained by connection links when the chain is driven, cooperative interlocking between the drive links 100 is achieved. Therefore, it is possible to prevent in advance occurrence of a phenomenon in which the drive link 100 is caught by an object to be cut as the drive link 100 independently has an intermittent irregular operation.

Therefore, due to this fact, it is possible to achieve an effect of preventing in advance the loosening of the chain and the resultant release of the chain.

The drive link 100 has a substantially pentagonal plate shape, and is configured to have a jaw for forming a groove into which the sprocket of the chain saw is engaged between adjacent drive links 100.

The concave and convex portions 140 to be meshed with adjacent drive links 100 are formed on both sides of the drive link 100.

This is to achieve stable driving of the overall trajectory of the chain as drive links 100 adjacent to each other operate in an interlocked manner by being meshed with each other by the concave and convex portions 140 when the sprocket is driven according to the actuation of the chain saw.

The drive link 100 has mounting holes on both sides of the front surface thereof, and the side link 200 has pin holes 210 formed on both sides of the front surface thereof. O-ring grooves 132 are formed around both the mounting holes on the front and rear surfaces of the drive link 100, and O-rings 131 are interposed between the side links 200 and the drive link 100 to prevent in advance the possibility of a foreign matter to be introduced toward the connection pin 300.

For example, the O-ring groove 132 has a width of 0.8 mm and a depth of 0.4 mm, and the circular cross-section of the O-ring 131 has a diameter of about 0.4 mm.

When the side link 200 is positioned close to the drive link 100 and is fixed by the connection pin 300, a length between the wall surface of the side link 200 and the bottom surface of the O-ring groove 132 of the drive link 100 is about 0.25 mm, and only a fine gap (of 0.05 mm) which is an allowable tolerance may exist between the wall surface of the side link 200 and the wall surface of the drive link 100.

Hereinafter, pivot coupling according to driving of the chain of the present disclosure will be described.

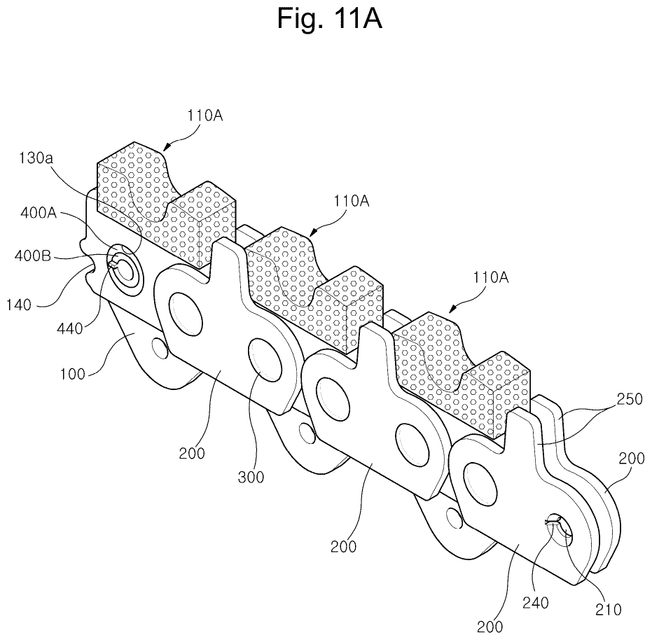

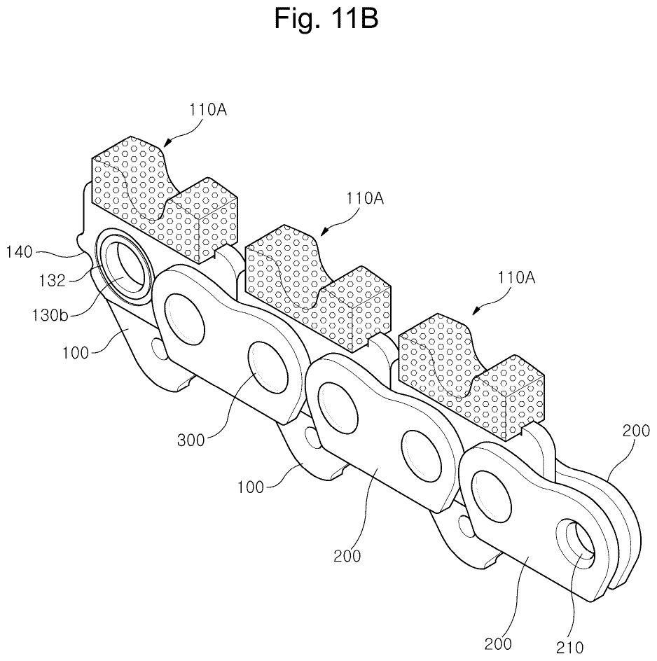

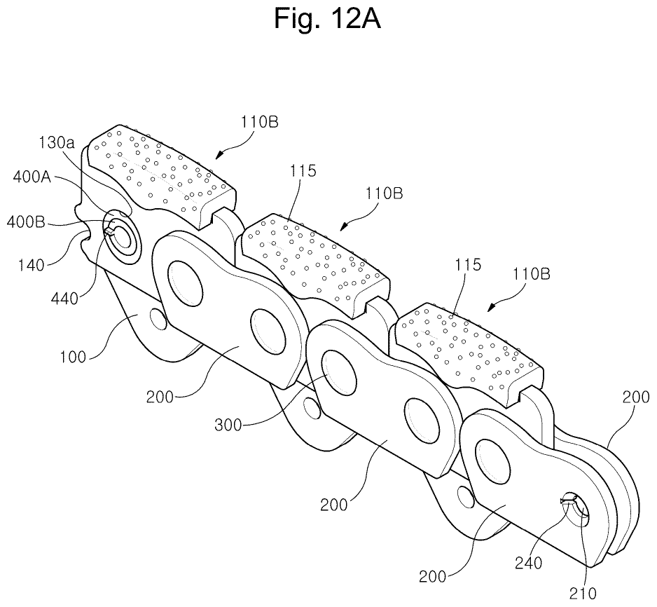

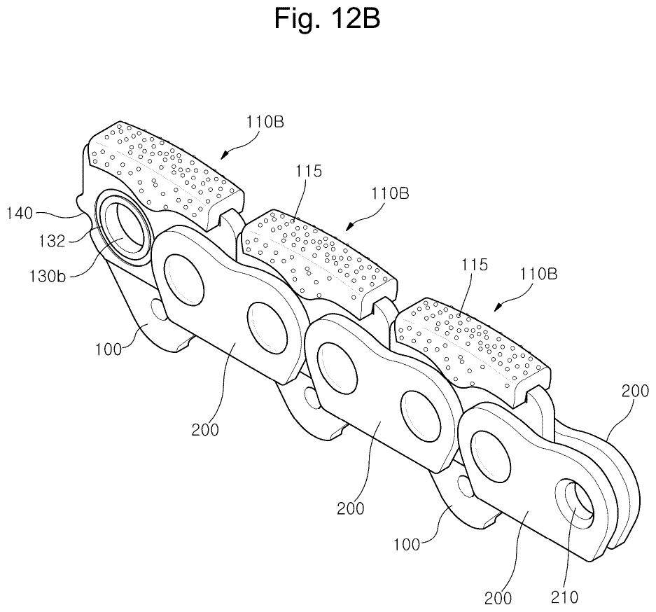

First, a pivot coupling scheme of the connection pin 300 by inner and outer bushings in accordance with a preferred embodiment of the present disclosure which are fitted into concentric circles of mounting holes 130a of the drive link 100 will be described (with reference to FIGS. 4a, 5a, 6a, 7a, 8a, 9a, 10a, 11a and 12a).

The mounting hole 130a of the drive link 100 is formed as an elliptical hole. The connection pin 300 is pivotally coupled into an outer bushing 400A which has an outer diameter corresponding to the elliptical hole and a circular inner bushing 400B which has an outer diameter to be inserted into the inner diameter of the outer bushing 400A.

Although not illustrated, the mounting hole 130a may be a circular hole, and the outer bushing 400A may be integrally fixed into the circular hole in a forced fit manner.

A protrusion 440 is formed on one surface of the inner bushing 400B, and a notch groove 240 is formed in the side link 200 at a corresponding position.

The inner and outer bushings 400A and 400B may be made of carbide or a high hardness material having wear resistance.

In the above example, while the mounting hole 130a is finely an elliptical hole, the mounting hole 130b which is pivotally coupled with the rib of the connection link is a circular hole.

A scheme in which the rib 220 of the side link 200 fitted into the mounting hole 130b being the circular hole of the drive link 100 is pivotally coupled will be described below (with reference to FIGS. 4b, 5b, 6b, 7b, 8b, 9b, 10b, 11b, 12b and 13).

The rib 220 which is axially coupled to the inner diameter surface of the mounting hole 130b of the drive link 100 is provided around the pin hole 210 on one surface of the side link 200.

This distributes concentration of friction between the drive link 100 and the side link 200 made of the same material only on the connection pin 300 made of a relatively soft material, thereby contributing to improving durability by minimizing wear friction while the chain saw is driven.

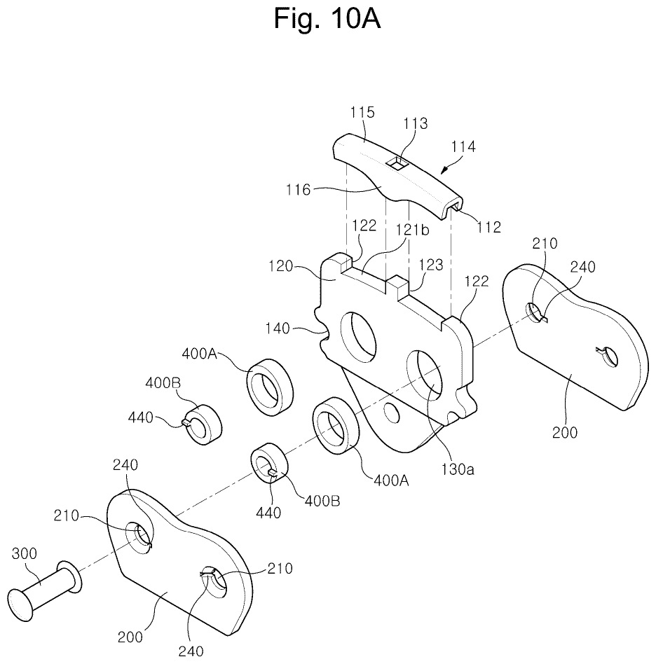

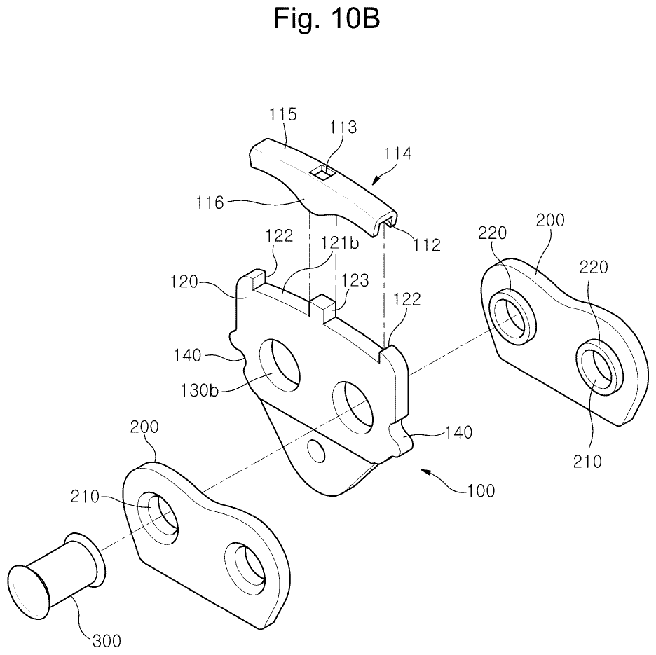

As illustrated in FIGS. 4b and 6b, the drive link 100 may be manufactured such that one side of the side link 200 overlaps with the drive link 100 and the connection pin 300 passes through the drive link 100 and the side link 200. As illustrated in FIGS. 9b and 10b, the connection pin 300 passes through the rib 220 of the side link 200, and the rib 220 of the side link 200 is pivotally coupled into the mounting hole 130b of the drive link 100. Therefore, since friction is generated between the drive link 100 and the side link 200 made of substantially the same material, a result of wear friction without great resistance is achieved.

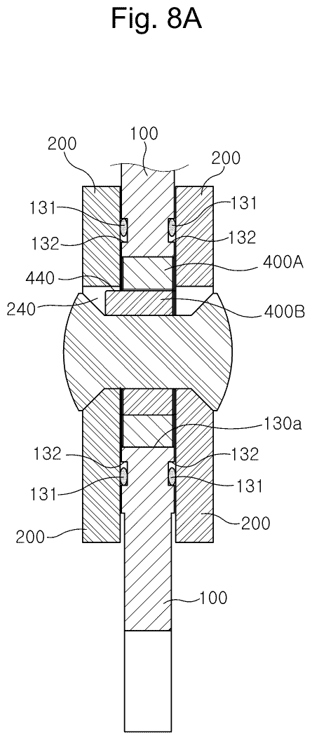

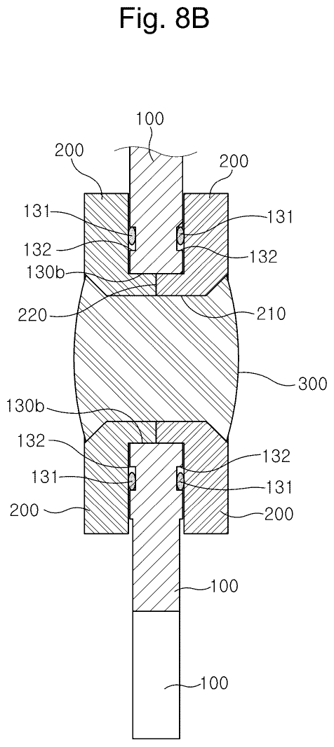

The mounting hole 130b of the drive link 100 may be formed to have an inner diameter similar to the outer diameter of the rib 220 of the side link 200. Therefore, as can be readily seen from FIG. 8b, the inner surface of the mounting hole 130b and the outer surface of the rib 220 in the curved section of an infinite trajectory of the chain are axially coupled to each other to avoid friction with the connection pin 300 made of a different material, thereby providing better functioning.

Thus, the drive link 100 and side link 200 may be formed of high carbon tool steel having a hardness of HRC58 or higher.

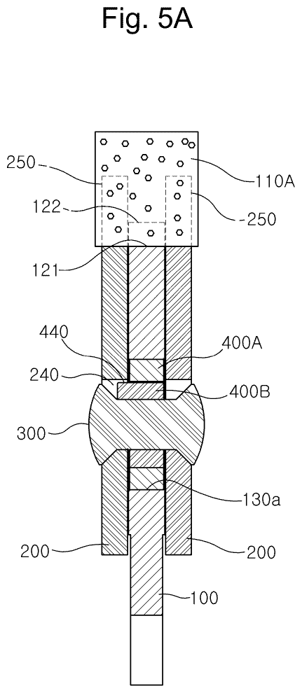

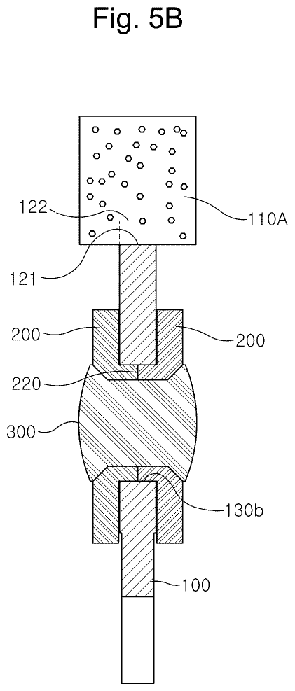

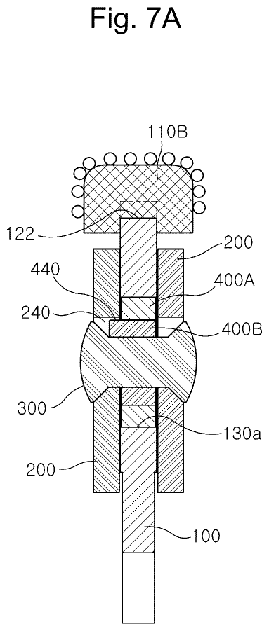

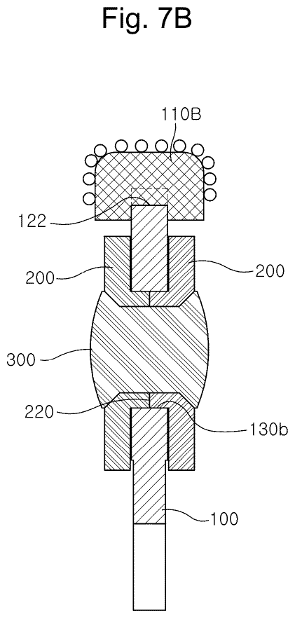

The side link 200 is a member which connects and locks neighboring drive links 100. As illustrated in FIGS. 4b and 6b, one side of the side link 200 overlaps with one drive link 100, and the other side of the side link 200 overlaps with the other drive link 100. As the connection pins 300 pass through the overlapping portions of the side link 200 and the drive links 100, the side link 200 and the drive links 100 may be coupled to each other. As illustrated in FIGS. 5b and 7b, side links 200 may be disposed on both left and right sides with the drive link 100 interposed therebetween. As illustrated in FIGS. 9b and 10b, the side link 200 may include the pin hole 210 and the rib 220 on each side.

The pin hole 210 may be formed at each of both sides of the side link 200. As illustrated in FIGS. 8b, 9b and 10b, in a state in which the pair of side links 200 are disposed with the drive link 100 interposed therebetween, the pin hole 210 may be disposed concentrically with the mounting hole 130b of the drive link 100. The outer diameter of the rib 220 may be formed as a diameter slightly smaller than the mounting hole 130b.

As illustrated in FIGS. 9b and 10b, the rib 220 is formed to protrude on one surface of the side link 200 along the circumference of the pin hole 210, and is of a hollow shape having an outer diameter to the extent that friction is generated when the rib 220 is fitted into the mounting hole 130b. As illustrated in FIG. 8b, the rib 220 may be formed to a protruding height that allows ribs 220 on both front and rear sides come into contact with each other in a state in which the ribs 220 are fitted into the mounting hole 130b. The ribs 220 in the mounting hole 130b may be in contact with each other or be spaced apart from each other, or may be installed such that their distal ends overlap with each other.

As illustrated in FIGS. 8a and 8b, due to the fact that the O-ring 131 is inserted in the O-ring groove 132 of the drive link 100, it is possible to prevent a foreign matter from being introduced toward the connection pin 300 from the periphery of the rib 220.

That is to say, since driving force of the chain sprocket is first applied to the drive link 100, is transmitted to the side link 200 and is then applied to the connection pin 300, in the present disclosure, it is possible to obtain a structure in which large force is not applied to the connection pin 300.

Therefore, an increase in length of the chain according to the operation of the chain is minimized due to friction between link structures processed to have high strength. In particular, since friction by contact between the rib 220 of the side link 200 and the outer surface of the connection pin 300 is significantly reduced, it is possible to minimize the wear of the connection pin 300 which is weak.

In this way, friction generated at coupling portions of the drive link 100, the side link 200 and the connection pin 300 may be limited to the drive link 100 and the side link 200.

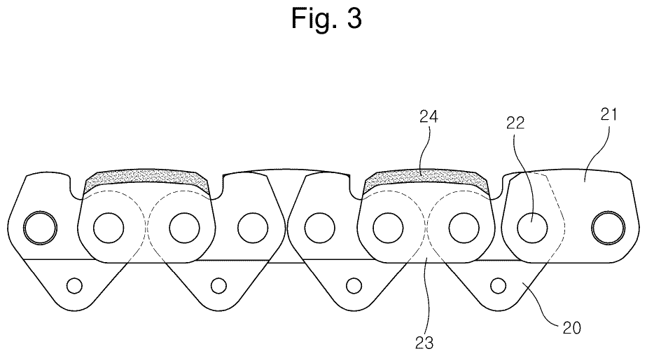

In the conventional structure in which the drive link 20, the side link 21 and the cutting link 23 are coupled by the connection pin 22 as illustrated in FIG. 3, friction generated in the curved section of an infinite trajectory is concentrated on the connection pin 22. In the present disclosure, due to the above-described structure, a phenomenon in which the connection pin 300 is deformed or damaged by concentrated friction may be prevented in advance.

In addition, in the conventional art, the abrasive cannot help but be formed to be relatively unnecessarily thick due to installation of the abrasive on a pair of cutting links 23 for an operation of driving the chain. In the present disclosure, it is possible to provide an effect of achieving smooth driving by minimizing a phenomenon in which vibration occurs.

In the present disclosure, the connection pin 300 normally exemplifies a rivet.

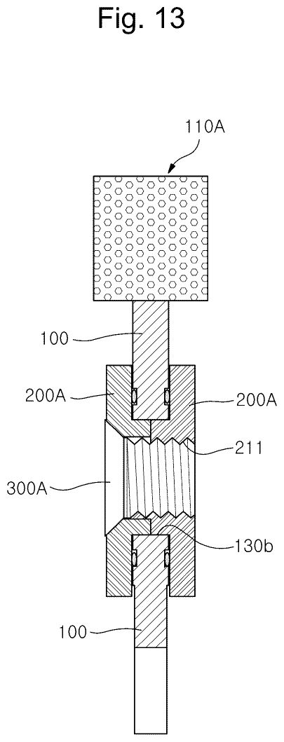

However, in case of loss of rivets in a field, a repair kit for replacement as illustrated in FIG. 13 is provided.

The repair kit includes a side link 200A for repair in which a female screw portion 211 is formed on the inner surface of the pin hole 210 of the side link 200, and a bolt 300A instead of the connection pin 300 may be coupled to the female screw portion 211 for replacement connection.

The replacement kit may be used when it is necessary to remove a unit due to release of the tip of any one drive link or increase in the length of the chain attributable to an abnormal operation.

There may be no replacement tool and device in the field.

Therefore, the replacement kit may be simply and easily used in a screw fastening pattern to perform its function.

Based on the above description, it will be understood by those skilled in the art that the present disclosure may be implemented in a different specific form without changing the technical spirit or essential characteristics thereof. Therefore, it should be understood that the above embodiments are not limitative but illustrative in all aspects. The scope of the present disclosure is defined by the appended claims rather than by the description preceding them, and thus all changes and modifications that fall within metes and bounds of the claims or equivalents of such metes and bounds are therefore intended to be embraced by the claims.

What is claimed is:

1. A chain of a chain saw, comprising:
a chain link segment in which a drive link formed with mounting holes on both sides thereof and a pair of side links each formed with pin holes on both sides thereof are coupled by a connection pin to form a track,
wherein an outer bushing having an outer diameter to be force-fitted into the mounting hole of the drive link as a circular hole is coupled to the mounting hole, and an inner bushing having an outer diameter to be inserted into a circular inner diameter of the outer bushing is coupled.

2. The chain according to claim 1, wherein a protrusion is formed on one surface of the inner bushing, and a notch groove is formed in the pin hole of the side link at a corresponding position.

3. The chain according to claim 1, wherein concave and convex portions which are engaged with adjacent drive links are formed on both sides of the drive link.

4. The chain according to claim 1, wherein a sintering tip is attached and fixed by forming a groove for coupling the sintering tip on an upper portion of the drive link to form engagement projections.

5. The chain according to claim 1, wherein a groove which has a gently convex arc is formed on an upper portion of the drive link, and a fusion tip is coupled by forming engagement projections at left and right ends of the groove.

6. The chain according to claim 1, wherein at least one coupling protrusion is formed in the groove of the drive link for coupling the fusion tip.

7. The chain according to claim 6, wherein the fusion tip fixed to the groove is formed by fusing diamond powder to an upper surface of a drive link cap which has a gently convex arc having a channel-shaped cross-section to form a groove covering a bottom of the gently convex arc-shaped groove of the drive link and front and rear wall surfaces of the drive link.

8. The chain according to claim 7, wherein a coupling hole into which the coupling protrusion is fitted, is formed at a predetermined position on the drive link cap.

9. The chain according to claim 6, wherein round type protruding pieces are provided on central front and rear portions of the drive link cap.

10. The chain according to claim 1, wherein an O-ring groove in which an O-ring is disposed is formed in each of front and rear surfaces of the drive link around the mounting hole formed on each of both sides of the drive link, and is covered by each of the pair of side links.
